(19) United States
(12) Patent Application Publication
(10) Pub. No.: US 2006/0232656 A1
(43) Pub. Date: Oct. 19, 2006

(54) Thermal printer, print head, printing method and substrate for use therewith

(75) Inventors: Robert F. Mindler, Churchville, NY (US); Rickie A. Angie, Rochester, NY (US); David B. Hilton, Webster, NY (US); Theodore J. Skomsky, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/106,836

(22) Filed: Apr. 15, 2005

(51) Int. Cl. B41J 2/315

(52) U.S. Cl. 347/171

(57) ABSTRACT

A print head 110 has a ceramic substrate 116 with a thermal bead 115 and a built in separating structure 114, 124 that is either a polished edge 114 or a second bead. The edge 114 or the bead 124 can provide a peel structure that can be used to separate donor web from the receiver sheet at a point after printing where donor material that is transferred to the receiver sheet is still generally in a liquid state.

### FIELD OF THE INVENTION

This invention relates in general to apparatus and methods for printing and in particular to printing heads and printing methods.

### BACKGROUND OF THE INVENTION

Many photographers use digital cameras to capture images. Unlike conventional wet processing of silver halide film and papers, digital images can be printed directly onto sheets of paper or other receiver media. In the ensuing paragraphs, discussions will be made in terms of paper stock as the receiver media. It is understood that paper stock is used as an illustration and not as a limitation of any invention. Color images may be printed using ink jet printers, multicolor transferable toner printers, heat sensitive coated paper printers, or thermal dye transfer printers. Many mass-market retail establishments have user-friendly kiosks where shoppers may make color prints. A large number of these kiosks use thermal dye transfer printers.

Conventional thennal transfer printer operations include: loading the paper or other receiver medium, printing on the receiver medium by transferring in an imagewise fashion and ejecting the completed print. Each of these operations is fully described in commonly assigned U.S. Pat. No. 5,176,458 which was issued to H. G. Wirth on Jan. 5, 1993. The disclosure of that patent is hereby incorporated into this specification by reference.

A key component of a conventional thermal dye transfer printer is the thermal print head. The thermal print head has a ceramic substrate side and a circuit board side bonded together to an aluminum backer plate (FIG. 1). The ceramic substrate side has a plurality of thermal resistors (heater line) for transferring a donor material from a ribbon onto paper. The circuit board has integrated circuits laterally spaced from the ceramic substrate on the bottom and connectors on the top to supply power and data for selectively operating the thermal printing elements. The integrated circuit is enclosed in a protective housing that has two walls and a cover between the walls, with one wall distal from the ceramic substrate and transverse to the substrate and the other wall proximate to the ceramic substrate and varying in height from a minimal level proximate the level of the substrate to a maximum level of the cover.

Thermal dye transfer printers create continuous tones of specific colors not unlike those of traditional color photo prints. Whereas traditional color photos use dyes and fine grains of silver salts, chemically processed to produce an image, thermal printers achieve continuous tones by laying their cyan, yellow and magenta dyes on top of each other with repeated passes of the paper past the print head. (Some thermal printers also add black dye to the final process). Thermal dye transfer printers also have the capacity to use the heat from the heat line to transfer a clear plastic layer over the completed print, sealing the print and giving the final product an estimated 100-year lifespan.

An example of a thermal dye transfer printer that provides monotone, multi-tone or full color printing are shown in FIGS. 1 and 2. Referring now to FIG. 1 there is shown a thermal printer 10 having a conventional thermal print head 25 with thenmal resistors 44 that are arranged in a linear array and that generate heat in proportion to an amount of electrical energy that passes through thermal resistors 44. Such a linear arrangement of thermal resistors 44 is commonly known as a heat line or print line. The terms “linear array of thermal resistors”, “heat line” and “print line” are used interchangeably in this patent. A donor supply roll 20 on one side of thermal print head 25 provides a web of thermal transfer donor web 21 that travels across the linear array of thenmal resistors 44 (heat line) and is wound on a donor take-up reel 22. Donor web 21 may comprise a single color for monotone printing, but it preferably comprises at least three sequential sections of different colors in order to provide full-color print and a clear section for applying a protective cover on the print. Beneath print head 25 is a cylindrical platen 50. Platen 50 is coupled to a platen stepper motor 51 by a suitable transmission 32 such as a belt. Those skilled in the art understand that FIG. 1 is schematic in nature and other suitable means are possible for connecting platen stepper motor 51 to cylindrical platen 50 in order to turn platen 50. Such other means include and are not limited to gear trains. Thermal print head 25 is coupled to control circuit 60. Control circuit 60 is coupled to a further motor (not shown) that controls the vertical position of thermal print head 25. In operation, control circuit 60 operates the motor (not shown) or solenoid in order to move thermal print head 25 in the direction shown by the arrow 3. Paper or other image receiver material is stored in a hopper 12. A top receiver sheet 8 or image receiver material is removed from hopper 12 by a suitable pick roller 11. Receiver sheet 8 travels along a printing path that leads it between surface guides 13, 14, urge rollers 15, 16, platen 50, exit guides 53, 54 and exit urge rollers 56, 57, into exit hopper 62.

Control circuit 60 is connected to the moveable and operative elements of printer 10 for controlling their individual and coordinated operation. Those skilled in the art understand that control circuit 60 is a schematic representation for a hard wired controller or a processor controlled system that uses a combination of software and hardware to control and operate printer 10 and its components. Those skilled in the art also understand that printer 10 may have different mechanisms for moving the receiver sheet past print head 25.

As shown in FIG.2, print head 25 has an integrated circuit board 101 has one or more integrated circuits that control the flow of electricity to thermal resistors 44 that are fabricated in a thermal head 105 of a ceramic substrate 106. The underside of the integrated circuit board 101 is protected by a board cover 107. A connector 102 on the top side of the integrated circuit board 101 receives power and control signals from printer controller 60. A heat sink 103, typically in the form of an aluminum backing plate, is fixed to the top side of ceramic substrate 106. Heat sink 103 rapidly dissipates heat generated by the thermal resistors 44 that are fabricated into thermal head 105 of ceramic substrate 106. An edge 104 of ceramic substrate 106 is typically sharp and may tear donor web 21 if brought into contact therewith.

As shown in FIG. 1, and in greater detail in FIG. 2, a conventional stand alone peel plate 70 is provided in printer 10 at a distance D from thermal print head 105. Stand alone peel plate 70 penetrates the plane of the lower surface of substrate 106. Thus, a conventional peel plate 70 performs two functions: it separates donor web 21 from receiver sheet 8, and it protects donor web 21 from sharp edge 104 by altering the path of donor web 21 to travel away from sharp edge 104 as donor web 21 passes the trailing end of ceramic substrate 106.

One or more manufacturers supply printers where the heat sink extends beyond the ceramic substrate and acts as a peel plate. However, those designs require that the aluminum heat sink have an edge that is precisely aligned with the substrate during assembly and further require additional space within the printer to accommodate the extended heat sink.

Thermal dye transfer printers also experience a problem known as ribbon sticking or cyan sticking. This problem occurs when portions of donor web 21 stick to receiver sheet 8 after donor web 21 is separated from receiver sheet. The stuck portions of donor web 21 degrade the appearance of the image on receiver sheet 8. Accordingly, when a portion of donor web 21 sticks, the print likely must be made again. Sometimes donor web 21 that remains attached to receiver sheet 8 will jam the printer. Then the printer must be stopped, opened, and cleared. Such sticking problems can also cause donor web 21 to be severed and a new donor web 21 may have to be installed.

The ribbon sticking problem is ubiquitous in many makes and models of thermal dye transfer printers. Because this problem is wide spread and recurs in numerous products, it would be a distinct advantage to provide a solution to the problem and thereby minimize or eliminate the problem of ribbon sticking, and to do so in a manner that allows further miniaturization of a thermal printer.

### SUMMARY OF THE INVENTION

The invention provides a solution to the problem of ribbon sticking. As a result, the improved printer has fewer parts, no longer requires a separate peel plate, eliminates the need for assembling and aligning the peel plate inside the printer, and provides high quality, glossy prints.

In one aspect of the invention, a thermal printer 10 is provided. Thermal printer 10 has a donor web 21 with multiple sequential sets of colored donor material or protective donor material; a supply of receiver sheets 8 for receiving the donor material from the donor web to render a visible image; a print head 110 moveable relative with respect to donor web 21 and receiver sheets 8 for engaging the donor web to press donor web 21 against receiver sheet 8. Print head 110 has a circuit board 111, 121 for carrying an integrated circuit to control operation of a plurality of thermal resistors 44; a connector 112, 122 for connecting the integrated circuit to a source of thermal resistor control signals; a ceramic substrate 116, 126 for holding the thermal resistors, the ceramic substrate having one end proximate the circuit board and another end distal from the circuit board with the thermal resistors disposed in the end distal from the circuit board. The thermal resistors are operable to heat, melt and transfer donor material from a donor web to a receiver sheet; a heat sink 113, 123 coupled to the ceramic substrate for removing heat from the substrate. A separating surface 114, 124 is provided on an edge at the distal end of the ceramic substrate for use in separating the donor web from the receiver sheet.

In another aspect of the invention, a thermal print head is provided. The thermal print head has a circuit board for carrying an integrated circuit to control operation of a plurality of thermal resistors and a connector for connecting the integrated circuit to a source of resistor control signals. A ceramic substrate is provided for holding the thermal resistors, the ceramic substrate having one end proximate the circuit board and another end distal from the circuit board; one or more rows of thermal resistors on the ceramic substrate and disposed in the end distal from the circuit board, the thermal resistors operable to heat, melt and transfer dye in a liquid state from a donor web to a receiver sheet. A heat sink is coupled to the ceramic substrate for removing heat from the substrate; and a separating surface is provided on an edge of the ceramic substrate proximate to the thermal resistors for use in separating the donor web from the receiver sheet, while the transferred donor material is in a generally liquid state.

In yet another aspect of the invention, a thermal print head is provided. The thermal print head has a circuit board for carrying an integrated circuit to control operation of a plurality of thermal resistors; a connector for connecting the integrated circuit to a source of resistor control signals and a ceramic substrate for holding the thermal resistors, the ceramic substrate having one end proximate the circuit board and another end distal from the circuit board. A heat sink is coupled to the ceramic substrate for removing heat from the substrate. The thermal resistors are disposed in the end distal from the circuit board, and are operable to heat, melt and transfer donor material from a donor web to a receiver sheet. A means integral with the ceramic substrate is disposed adjacent to the thermal resistors for separating the donor web from the receiver sheet after donor material has been applied thereto.

In still another aspect of the invention, a method for printing is provided. In accordance with the method, a donor web is fed past a thermal print head; a receiver sheet is registered with the donor web; the print head is moved relative to the donor web and the receiver sheet to engage the print head with the donor web and to engage the donor web with the receiver sheet; thermal resistors in the print head are selectively energized to heat and to melt donor material on the donor web in order to transfer the donor material from the donor web in a liquid state to the receiver sheet in a liquid state; and the donor web is separated from the receiver sheet while the dye is still in a generally liquid state.

In a further aspect of the invention, a ceramic substrate is provided for use in a thermal print head. The ceramic substrate has a base with a proximate end and a distal end. An array of thermal resistors is provided proximate to the distal end and a curved edge surface is provided between the thermal resistors and the distal end, with the curved edge surface being shaped so that a donor web can be drawn against the curved edge surface without damage to the donor web.

### BRIEF DESCRIPTION OF THE DRAWING

FIG. 1 shows a schematic view of a printer with the conventional print head of FIG. 2 and separate peel plate structure;

FIG. 2 shows a conventional print head with a sharp ceramic edge;

FIG. 3 shows a print head with one embodiment of the invention; and

FIG. 4 shows a print head with a second embodiment of the invention.

### DETAILED DESCRIPTION OF THE INVENTION

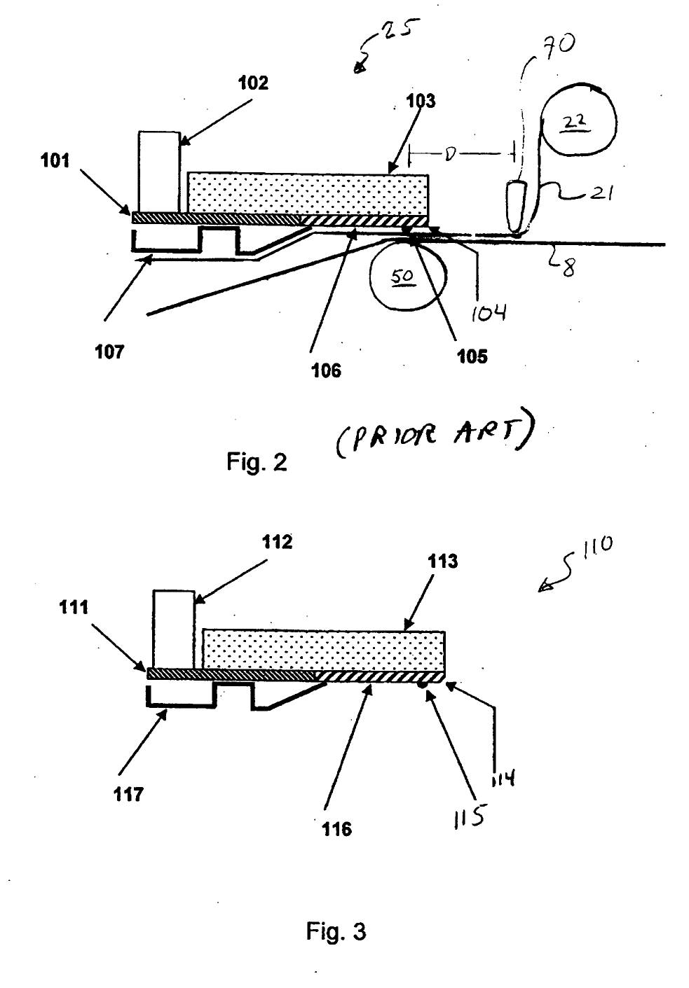

FIG. 3 shows one embodiment of a print head 110 of the invention. Print head 110 has an integrated circuit board 111 which carries one or more integrated circuits that control the flow of electricity to a heat line that is fabricated in this embodiment in a thermal bead line 115 of ceramic substrate 116. The underside of the integrated circuit board 111 is protected by a board cover 117. A connector 112 on the top side of the integrated circuit board 111 receives power and control signals from a printer controller. A heat sink 113, typically in the form of an aluminum backing plate, is fixed to the top side of the ceramic substrate 116. Heat sink 113 rapidly dissipates heat generated by thermal resistors 44 that are fabricated into a linear array referred to herein as a thermal bead line 115 of the ceramic substrate 116.

It will be appreciated that donor material on donor web 21 undergoes several changes in state when it is transferred to receiver sheet 8 using a thermal process. Upon initial transfer to the receiver sheet 8, donor material is liquid and hot. Within a short period of time, the donor material enters a transition or glassy state. Finally, the donor material becomes solid when it is cool. The physical state of the donor material depends upon its temperature and the temperature decreases from hot to cool over a period of time.

The temperature of the donor material at the time of separation (peeling) from receiver sheet 8 is a function of time since heating. Because donor web 21 and receiver sheet 8 travels at a constant speed, the time of separation and thus the physical state of the dye is determined by location of the separating structure (peel plate) with respect to thermal bead line 115. The closer that separation is performed with respect to thermal bead line 115, the hotter the dye and the more likely the dye is in a liquid state. As the separation is performed further away from thermal bead line 115, the donor material becomes glassy and at some still further separation the donor material is solid.

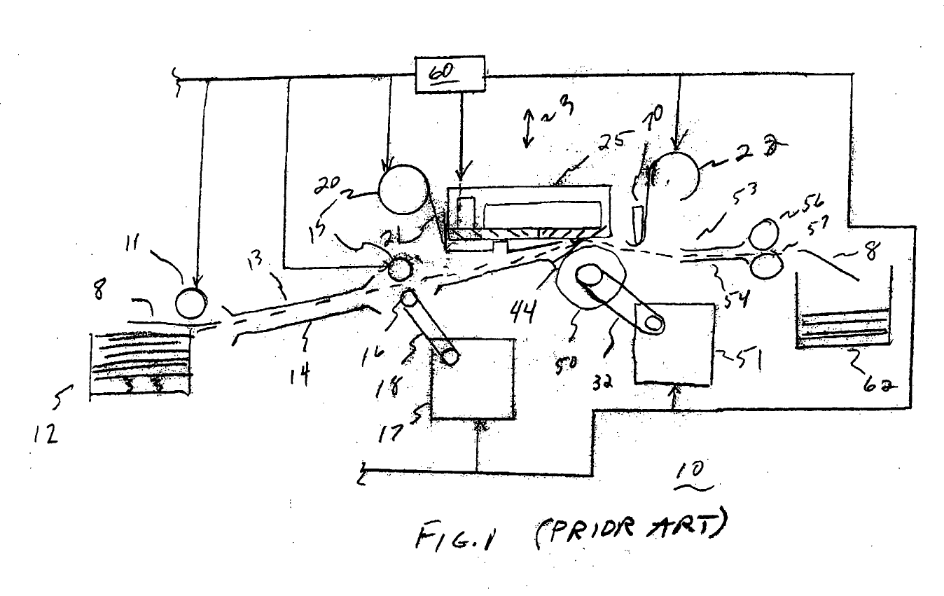

As shown in FIGS. 1 and 2, a printer 10 that uses a conventional stand alone peel plate positions the peel plate 70 at a distance D from thermal resistors 44. Typically, distance D is far enough from the thermal resistors 44 to allow the donor material to enter into the solid state before separation performed. This is done in order to avoid the sticking problem which is most acute when donor web 21 is separated from receiver sheet 8 when the donor material is in its transition or glassy state. However, as noted above, this approach causes the overall size of a conventional printer to be increased to allow for the separation. Further, this approach increases the overall cost of a conventional printer by requiring that conventional printer 10 provide both the stand alone peel plate and provide structures that support and properly align the stand alone peel plate with the donor medium.

As shown in FIG. 3, print head 110 of present invention eliminates the need for stand alone peel plate 70 or alternately, the extended heat sink of the prior art. Instead, in the embodiment of FIG. 3, edge 114 of ceramic substrate 106 is used to separate donor web 21 and receiver sheet 8. Unlike the sharp edges of ceramic substrate 106 of prior art print head 25, edge 114 of the substrate 116 is either polished smooth or fabricated with a curved, radius edge. The edge 114 performs the same functions as a conventional stand alone peel plate by being shaped to facilitate separation of donor web 21 from receiver sheet 8 without risk of damage. In addition, this allows curved edge 114 to be positioned so that the point of separation of donor web 21 from receiver sheet 8 is proximate to thermal bead 115, thus separation can be performed where the donor material is hot and generally liquid. In some embodiments, this separation can be on the order of less than 15 mm.

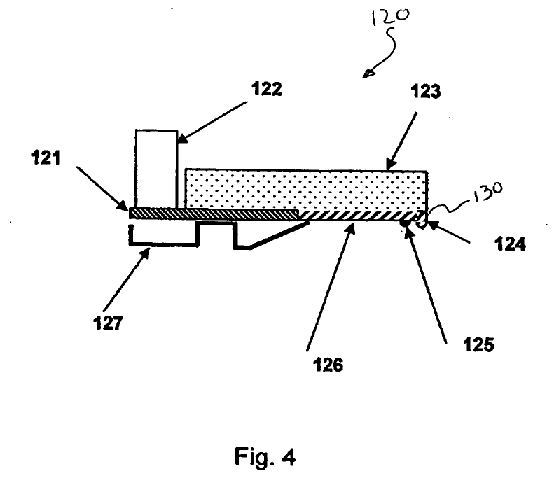

Turning now to FIG. 4, there is shown a second embodiment of a print head 120 of the invention. In this embodiment, print head 120 has an integrated circuit board 121 which carries one or more integrated circuits that control the flow of electricity to thermal resistors 44 that are fabricated in a linear array comprising a thermal bead 125 on ceramic substrate 126. The underside of the integrated circuit board 121 is protected by a board cover 127. A connector 122 on the top side of the integrated circuit board 121 receives power and control signals from control circuit 60. A heat sink 123, typically in the form of an aluminum backing plate, is fixed to the top side of the ceramic substrate 126. Heat sink 123 rapidly dissipates heat generated by thermal resistors 44 that are fabricated into thermal bead 125.

In this embodiment, ceramic substrate 126 has smooth bead 124 fabricated proximate to a trailing edge 130 of ceramic substrate 126. Smooth bead 124 provides a smooth surface for use in separating donor web 21 from receiver sheet 8, without risk of damage to donor web 21. In addition, smooth bead 124 reduces the distance between the thermal bead 125 and the point of separation of donor web 21 and receiver sheet 8, thus providing a separating point where the donor material that has been applied to receiver sheet 8 is generally liquid. As such, smooth bead 124 not only avoids the problem of damaging donor web 21, but also provides a peel structure that is closer to thermal bead 125 than can be provided using a separate peel plate. This also allows greater miniaturization of a thermal printer having a print head 120.

Having thus described several embodiments of the invention, those skilled in the art will understand that further modifications, additions, deletions, substitutions and changes may be made to the disclosed embodiments without departing from the spirit and scope of the invention as set forth in the appended claims. Those skilled in the art further understand that the disclosed embodiments of the invention eliminate a separate peel plate element from the printer. With the invention the print head, and, in particular, the ceramic substrate, now perform the ribbon-receiver separating function formerly performed by the peel plate.

### PARTS LIST

8 top receiver sheet
10 thermal printer
11 pick roller
12 hopper
13 surface guide
14 surface guide
15 urge roller
16 urge roller
20 donor supply roll
21 donor web
22 donor take-up reel
25 print head
32 suitable transmission
44 thermal resistors
50 cylindrical platen
51 platen stepper motor
53 exit guide
54 exit guide
56 exit urge roller
57 exit urge roller
60 control circuit
62 exit hopper
70 conventional stand alone peel plate
101 integrated circuit board
102 connector
103 heat sink
104 edge
105 thermal print head
106 ceramic substrate
107 board cover
110 print head
111 integrated circuit board
112 connector
113 heat sink
114 edge
115 thermal bead
116 ceramic substrate
117 board cover
120 print head
121 integrated circuit board
122 connector
123 heat sink
124 smooth bead
125 thermal bead
126 ceramic substrate
127 board cover
130 trailing edge of ceramic substrate

1. A thermal printer comprising:
a donor web (21) having multiple sets of colored donor material or protective donor material;
a supply of receiver sheets (8) for receiving donor material from the donor web to render a visible image;
a print head (110) moveable relative with respect to the donor web and the receiver sheets for engaging the donor web to press the donor web against a receiver sheet, said print head comprising
a circuit board (111, 121) for carrying an integrated circuit to control operation of a plurality of thermal resistors;
a connector (112, 122) for connecting the integrated circuit to a source of thermal resistor control signals;
a ceramic substrate (116, 126) for holding the thermal resistors, said ceramic substrate having one end proximate the circuit board, another end distal from the circuit board, and further comprising an edge with said thermal resistors (44) disposed in the end distal from the circuit board, said thermal resistors operable to heat, melt and transfer donor material from the donor web to a receiver sheet;
a heat sink (113, 123) coupled to the ceramic substrate for removing heat from the substrate; and
a separating surface (114, 124) on an edge at the distal end of the ceramic substrate for use in separating the donor web from the receiver sheet after the donor material has been transferred to the receiver sheet.

2. The thermal printer of claim 1, wherein the separating surface comprises a curved, rounded, radius, polished or smooth edge.

3. The thermal printer of claim 1, wherein the separating surface comprises the distal edge of the ceramic substrate.

4. The thermal printer of claim 1, wherein the ceramic substrate has a planar surface and the separating surface extends below the planar surface.

5. The thermal printer of claim 1, wherein the separating surface is within 15 mm of the thermal resistors.

6. A thermal print head comprising:
a circuit board for carrying an integrated circuit to control operation of a plurality of thermal resistors;
a connector for connecting the integrated circuit to a source of thermal resistor control signals;
a ceramic substrate for holding the thermal resistors, said ceramic substrate having one end proximate the circuit board and another end distal from the circuit board with the thermal resistors on the ceramic substrate and disposed in the end distal from the circuit board, said thermal resistors operable to heat, melt and transfer donor material from a donor web to a receiver sheet while the donor material is in a liquid state;
a heat sink coupled to the ceramic substrate for removing heat from the substrate; and
a separating surface on an edge of the ceramic substrate proximate to the plurality of thermal resistors and shaped for use in separating the donor web from the receiver sheet while the transferred donor material is in a generally liquid state.

7. The thermal print head of claim 6, wherein the separating surface comprises a curved, rounded, radius, polished or smooth edge.

8. The thermal print head of claim 6, wherein the separating surface comprises the distal edge of the ceramic substrate.

9. The thermal print head of claim 6, wherein the ceramic substrate has a planar surface for and the separating surface on the edge extends below the planar surface.

10. The thermal print head of claim 6, wherein the separating surface is within 15 mm of the thermal resistors.

11. A thermal print head comprising:
a circuit board for carrying an integrated circuit to control operation of a plurality of thermal resistors;
a connector for connecting the integrated circuit to a source of thermal resistor control signals;
a ceramic substrate for holding the thermal resistors, said ceramic substrate having one end proximate the circuit board and another end distal from the circuit board;
a heat sink coupled to the ceramic substrate for removing heat from the substrate;
with said thermal resistors positioned on the ceramic substrate in the end distal from the circuit board, said thermal resistors operable to heat, melt and transfer donor material from a donor web to a receiver sheet; and
with a separating surface on an edge of the ceramic substrate proximate to the thermal resistors for use in separating the donor web from the receiver sheet while the transferred material is in a generally liquid state.

12. The thermal print head of claim 11, wherein the means integral with the ceramic substrate or the heat sink for separating the dye transfer sheet from the ceramic substrate comprises an edge of the ceramic substrate, said edge being distal from the integrated circuit and having a rounded, radius or smooth edge.

13. The thermal print head of claim 12, wherein the edge for separating the donor web from the receiver sheet projects toward the donor web from the ceramic substrate.

14. A method for printing comprising:
feeding a donor web past a thermal print head;
registering a receiver sheet with the donor web;
moving the print head relative to the donor web and the receiver sheet to engage the print head with the donor web and to engage the donor web with the receiver sheet;
selectively energizing thermal resistors in the print head to heat and to melt donor material in order to transfer donor material from the donor web to the receiver sheet in a liquid state; and
separating the donor web from the receiver sheet while the transferred dye is still in a generally liquid state.

15. The method of claim 14, wherein said separation is performed by drawing the donor web against a curved surface of a ceramic substrate having said thermal resistors therein.

16. A ceramic substrate for use in a thermal print head, said ceramic substrate comprising:
a base having a proximate end and a distal end with an array of thermal resistors proximate to the distal end and with a curved edge surface between the thermal resistors at the distal end,
said curved edge surface being shaped so that a donor web can be drawn against the curved edge surface without damage to the donor web.

17. The substrate of claim 16, wherein said curved surface is within 15 mm of the thermal resistors.
